(19) United States
(12) Patent Application Publication
(10) Pub. No.: US 2011/0209207 A1
(43) Pub. Date: Aug. 25, 2011

(54) SYSTEM AND METHOD FOR GENERATING A THREAT ASSESSMENT

(75) Inventors: Alfredo C. Issa, Apex, NC (US); Richard J. Walsh, Raleigh, NC (US)

(73) Assignee: OTO TECHNOLOGIES, LLC, Raleigh, NC (US)

(21) Appl. No.: 12/712,409

(22) Filed: Feb. 25, 2010

(51) Int. Cl. H04L 9/32; G06F 21/00; G06F 15/16

(52) U.S. Cl. 726/7; 726/23; 709/206

(57) ABSTRACT

A method and system for quantifying a threat associated with a sender of a message. A threat assessment module receives a message from a sender directed toward a recipient. The threat assessment module accesses a behavioral data source to obtain an activity record identifying an activity of the sender. The activity record is analyzed to determine if the content of the activity record contains non-preferred content. A threat assessment quantifier is generated based on the analysis and sent toward the recipient.

### FIELD OF THE INVENTION

The present invention relates generally to messaging, and in particular to quantifying a threat associated with a message based on activity of the sender of the message.

### BACKGROUND OF THE INVENTION

Individuals receive messages from people they know well and from people they don't know at all. It may be easy for a recipient of a message to decide to view a message received from someone they know well, or to decide not to view a message received from someone they don't know at all. But it may be more difficult to decide whether to view a message received from an individual the recipient knows to some extent, but not well.

The availability and popularity of social networking tools has vastly increased the number of people from whom a recipient may receive a message. Social networking services such as Facebook and Linkedln enable people to “connect” to one another based on relationships, resulting in an almost exponential number of connections. Even if two subscribers are not directly connected to one another, such services may enable one subscriber of the service to send a message to another subscriber. Messages may include a variety of different types of content, including text, images, video, audio, and the like. Unfortunately, each type of content may contain offensive or otherwise unsuitable content from the perspective of the recipient. While a recipient of an offensive text-based message may be able to relatively easily ignore the message after reading it, it may be more difficult to disregard disturbing images that may be depicted in an image or video.

Often, if a recipient knew more about the sender of the message, the recipient might be able to make a more educated decision about the suitability of the content of a message prior to viewing the message. However, it is not practical to research the activities of all potential senders of a message. Accordingly, there is a need for a mechanism that can analyze the activity of a sender of a message and quantify the risk associated with a message sent by the sender based on such activity.

### SUMMARY OF THE INVENTION

The present invention relates to a method and system for quantifying a threat associated with a message based on behavioral activity of the sender. The message may be forwarded to the intended recipient along with an assessment of the threat for the recipient to use as desired.

According to one embodiment, a message recipient is a subscriber to a threat assessment service. The subscriber identifies one or more potential behavioral data sources that may contain data identifying activities of a sender. The activities of the sender may include, for example, content provided by the sender to the one or more behavioral data sources. The behavioral data sources may include, for example, a social networking website, a business networking website, a blog posting website, a photo sharing website, and the like. The subscriber may also provide to the threat assessment service credentials including user identifiers and passwords for enabling the threat assessment service to authenticate with one or more of the behavioral data sources.

The threat assessment service receives a message that is directed toward the subscriber. The threat assessment service identifies the sender of the message via information contained in the message, such as an email address; an IP address; metadata that may accompany the message, such as the first and last name of the sender; and the like. The threat assessment service then queries each of the identified behavioral data sources for activity records identifying activities of the sender. In particular, the threat assessment service may use the subscriber-supplied credentials to authenticate with the social networking website. Once authenticated, the threat assessment service may gain access to activities of the sender, such as textual postings of the sender, images shared by the sender, videos shared by the sender, or any other activity by the sender conducted on the social networking website. The social networking website may provide the activity records to the threat assessment service upon request, or the threat assessment service may “crawl” or otherwise search the social networking website to determine activities of the sender on the social networking website.

For each activity record obtained from the behavioral data source, the threat assessment service may analyze the content of the activity record and generate a record threat value based on the content. The content could include, for example, textual content, audio content, image content, or video content. Separate content analyzers for each type of content may be used to analyze the content. For example, a text content analyzer may parse the words of an activity record containing a textual posting of the sender. Each word in the posting may be compared to a non-preferred content list that identifies non-preferred words. For each non-preferred word, the non-preferred content list may include a non-preferred content value. The non-preferred content list may be configurable by the service provider, the subscriber (i.e., the recipient), or a combination of both. A record threat value may be obtained by summing the non-preferred content values of the non-preferred words in the activity record. As another example, an image analyzer may be used to analyze an activity record that includes an image that was posted by the sender. The image analyzer may analyze the image and determine that the image depicts non-preferred image content, such as bloodshed, firearms, inappropriate intimate behavior, and the like. A non-preferred content list may identify a non-preferred content value for each type of non-preferred image content. A record threat value may be obtained by summing the non-preferred content values associated with the depicted non-preferred image contents.

The threat assessment service can determine a threat assessment quantifier after analyzing the activity records from each of the behavioral data sources. The threat assessment quantifier may be expressed in any desired form, such as a particular number from a range of possible numbers, a letter from a set of finite letters, and the like. The threat assessment service directs the threat assessment quantifier and the original message toward the recipient. Additional information, such as data identifying the non-preferred content in the message, may also be directed toward the recipient.

The recipient's device may interpret the threat assessment quantifier and provide a threat assessment based on the threat assessment quantifier to the recipient. The recipient may choose to discard the message, view the message, or request to view additional information such as data identifying the non-preferred content.

Those skilled in the art will appreciate the scope of the present invention and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the invention, and together with the description serve to explain the principles of the invention.

FIG. 1 is a block diagram illustrating an exemplary system in which embodiments of the present invention may be practiced;

FIG. 2 is a flowchart illustrating a method for determining a threat assessment quantifier according to one embodiment of the invention;

FIG. 3 is block diagram illustrating functional and data blocks of a threat assessment module according to one embodiment of the invention;

FIG. 4 is a flowchart illustrating steps for analyzing an activity record according to one embodiment of the invention;

FIG. 5 is a flowchart illustrating steps for analyzing an activity record that contains textual content according to one embodiment of the invention;

FIG. 6 illustrates an exemplary non-preferred content list according to one embodiment of the invention;

FIG. 7 is a flowchart illustrating steps for analyzing an activity record that contains image content, such as a digital photograph, according to one embodiment of the invention;

FIGS. 8A-8C illustrate exemplary user interfaces for displaying a threat assessment based on a threat assessment quantifier; and

FIG. 9 illustrates an exemplary processing device that may implement a threat assessment module according to one embodiment of the invention.

### DETAILED DESCRIPTION

The embodiments set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The present invention relates to quantifying a potential threat associated with a message. The threat is quantified based on activity of the sender. The sender's activities, such as website postings of the sender and the like, are analyzed, and a threat assessment quantifier is generated. The threat assessment quantifier and the message are directed toward the recipient. The recipient may use the threat assessment quantifier to determine an appropriate action, such as discarding the message, viewing the message, and the like.

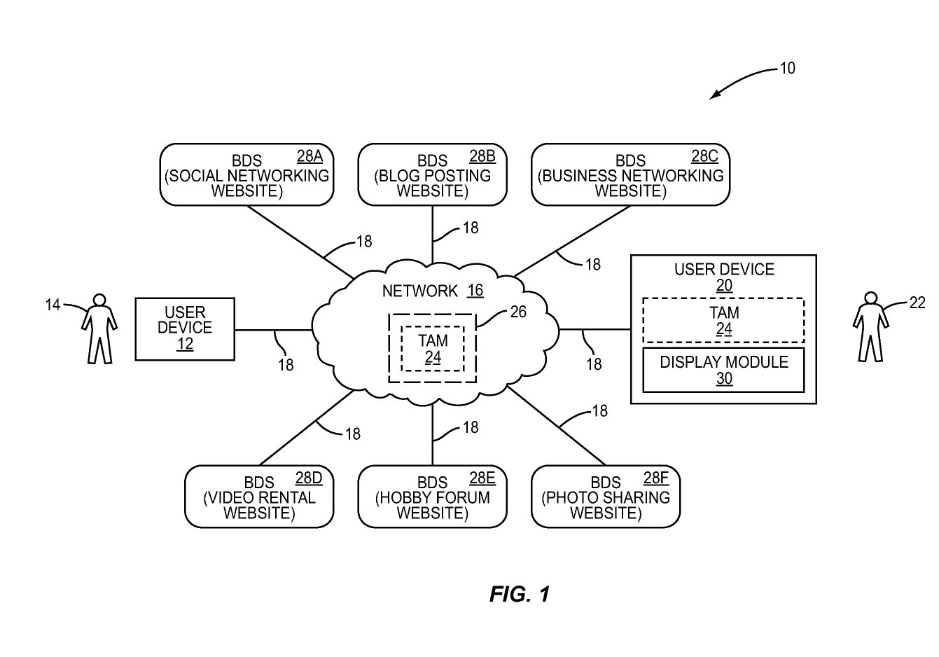

FIG. 1 is a block diagram of a system 10 in which one embodiment of the invention may be practiced, and will serve to illustrate a high-level overview of one embodiment of the invention. The system 10 includes a user device 12 associated with a sender 14. The user device 12 is coupled to a network 16 via an access link 18. The system 10 also includes a user device 20 associated with a recipient 22. Each of the user devices 12, 20 can comprise any suitable fixed or mobile processing device capable of engaging in message communications, including, for example, a Personal Digital Assistant (PDA), a mobile phone such as a cellular telephone, a laptop computer, a desktop computer, and the like. The access links 18 may comprise any suitable mechanism for communicatively coupling the user devices 12, 20 to the network 16, including, for example, a wired or wireless communications link such as Wi-Fi, GSM, CDMA, Ethernet, cable modem, DSL, and the like. The network 16 may comprise any suitable public or private network, or networks, or combination thereof, capable of transferring a message received from the user device 12 to the user device 20. According to one embodiment of the invention, the network 16 comprises the Internet.

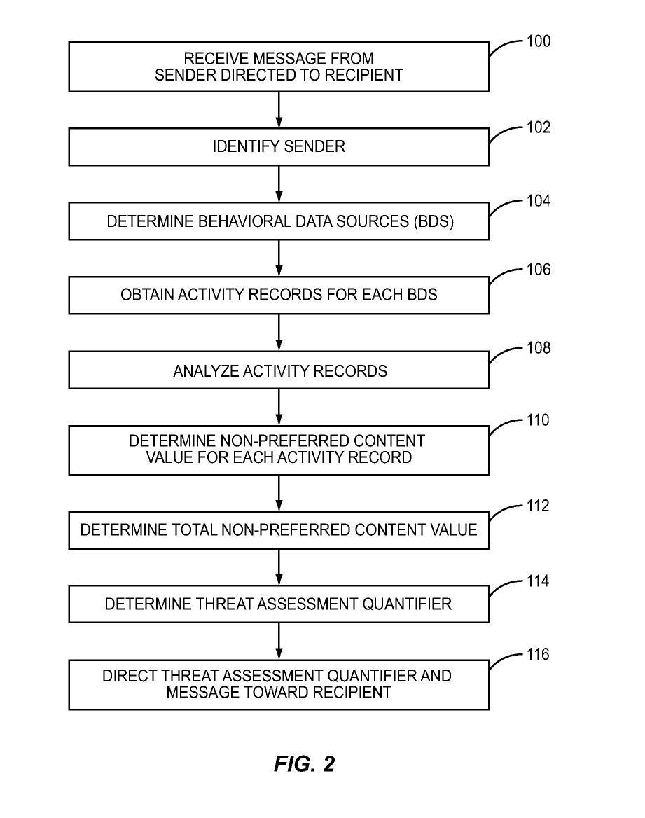

Aspects of the present invention may be implemented in a threat assessment module (TAM) 24. The TAM 24 may be implemented in a network element 26 such as a switch, a proxy server, and the like, which is part of, or coupled to, the network 16. Alternately or supplementally, the TAM 24 may be implemented in a user device, such as the user device 20. Alternately, the TAM 24 may be implemented in a residential network element (not shown), such as a router, a wireless access point, a cable modem, and the like. Functional blocks of the TAM 24 according to one embodiment will be described herein with respect to FIG. 2.

The TAM 24 receives a message sent toward the recipient 22 by the sender 14. In response to receiving the message, the TAM 24 accesses one or more behavioral data sources 28A-28F (generally, behavioral data sources 28). The TAM 24 obtains activity records which identify activities of the sender 14 from the behavioral data sources 28. Activities may include social network activities such as, for example, a textual posting of the sender 14, an image shared by the sender 14, a video shared by the sender 14, movies rented by the sender 14, a poll answered by the sender 14, blogs authored or responded to by the sender 14, and the like.

The TAM 24 conducts an analysis of the content of each activity record and, based on the analysis, generates a threat assessment quantifier. The threat assessment quantifier and the message are directed toward the recipient 22. For example, if the TAM 24 is implemented in the network element 26, the threat assessment quantifier and the message may be directed toward the recipient 22 by sending the threat assessment quantifier and the message to the user device 20. Alternately, if the TAM 24 is implemented in the user device 20, the TAM 24 may direct the threat assessment quantifier and the message to a display module 30 for display to the recipient 22. The display module 30 may display a window identifying the sender 14 and the threat assessment quantifier. The recipient 22 may view the threat assessment quantifier and determine an appropriate action, such as discarding the message or viewing the message. In one embodiment, the recipient 22 may be presented with data identifying, or describing, non-preferred content in the message. For example, the recipient 22 may be presented with a message that states “Message from Susan contains an image that depicts graphic violence.”

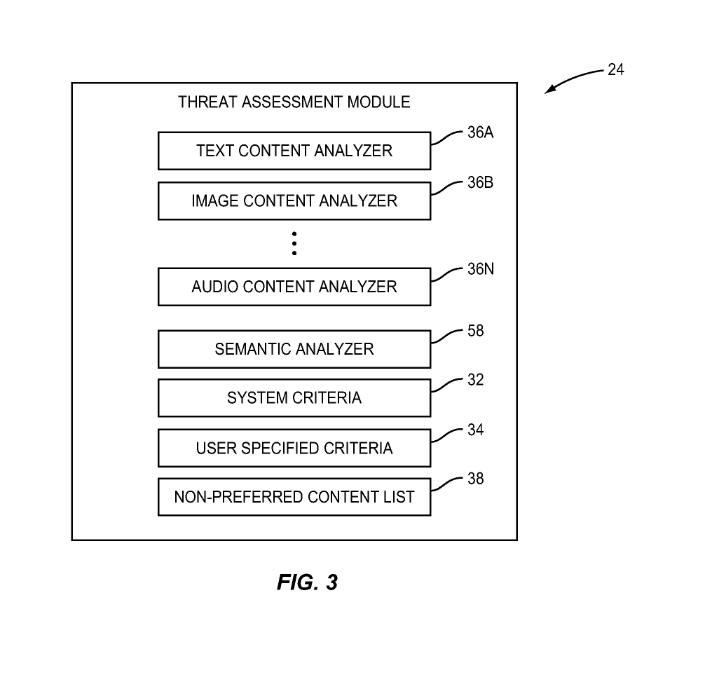

FIG. 2 is a flowchart illustrating a method for determining a threat assessment quantifier according to one embodiment of the invention. FIG. 3 is a block diagram illustrating functional and data blocks of the TAM 24 according to one embodiment of the invention. FIG. 2 will be discussed in conjunction with FIGS. 1 and 3. Assume that a service provider offers threat assessment as a service to its subscribers, and that the recipient 22 is a subscriber of such service. Assume further that the sender 14 sends a message toward the recipient 22, and that the TAM 24 receives the message from the sender 14 (step 100).

The TAM 24 identifies the sender 14 via information contained in the message, such as an email address, metadata that includes the name of the sender 14, a user identifier associated with the message, a phone number associated with the message, an equipment identifier number such as a media access control (MAC) address or International Mobile Equipment Identifier (IMEI), a network address such as an internet protocol (IP) address or Bluetooth address, a social network identifier associated with the message, or the like (step 102). The TAM 24 determines one or more behavioral data sources 28 from which activity records identifying an activity of the sender 14 may be obtained (step 104). According to one embodiment of the invention, one or more of the behavioral data sources 28 may be identified by the recipient 22, for example, when initially registering for the service.

The behavioral data sources 28 may comprise various sources accessible by the TAM 24 which may contain data identifying activities of the sender 14. The behavioral data sources 28 may include, for example, a social networking website 28A of which the recipient 22 and the sender 14 are members. Activity records from the social networking website 28A might include public postings of the sender 14, images shared by the sender 14, videos or audio files shared by the sender 14, and the like. Generally, an activity record may contain any data that identifies an activity of the sender 14. Other behavioral data sources 28 of which the recipient 22 may be a member may include a blog posting website 28B and a business networking website 28C. A behavioral data source 28 may also comprise a photo sharing website 28F via which the recipient 22 shares photos. An activity record obtained from the photo sharing website 28F may include a comment posted by the sender 14 in response to the posting of an image. The recipient 22 may also be a member of a hobby forum website 28E wherein members post questions, comments, and discussions about a particular hobby.

The TAM 24 may also determine other behavioral data sources 28 that are not provided by the recipient 22. For example, the TAM 24 may be aware of a number of predetermined popular websites that the TAM 24 accesses to determine if the sender 14 is a member of such website. For example, the TAM 24 may determine if the sender 14 is a member of a particular video rental website 28D via publicly available information, or via an application programming interface (API) offered by the video rental website 28D for such purpose. If so, activity records may indicate the movies rented by the sender 14, or comments posted by the sender 14 in response to viewing a rented movie.

According to another embodiment of the invention, the sender 14 may identify one or more behavioral data sources 28 from which the TAM 24 may obtain activity records. For example, the recipient 22 may choose to reject any messages received from any sender 14 who does not identify a behavioral data source 28 for threat assessment purposes. Upon receipt of a message from the sender 14, the TAM 24 may determine that the sender 14 has not identified any behavioral data sources 28 for threat assessment purposes, and send a message to the sender 14 indicating that the recipient 22 has elected not to receive messages from any sender 14 who does not identify a behavioral data source 28 to the TAM 24 for threat assessment purposes. The message to the sender 14 may include a link to a configuration page wherein the sender 14 may identify a behavioral data source 28 of which the sender 14 is a member, for use by the TAM 24. The configuration page may require the identification of one or more behavioral data sources 28 of which the sender 14 is a member, as well as user credentials identifying an account of the sender 14, to allow the TAM 24 to access the identified behavioral data sources 28.

When a behavioral data source 28 is identified to the TAM 24, either by the recipient 22 or the sender 14, credentials may also be provided to the TAM 24 which identify an account of the recipient 22 or the sender 14, and enable the TAM 24 to authenticate with the respective behavioral data source 28. For example, if the recipient 22 identifies the social networking website 28A of which the recipient 22 is a member, the recipient 22 may provide the TAM 24 with the user identifier and password of the recipient 22 for the social networking website 28A. The TAM 24 may use such credentials to authenticate with the behavioral data source 28 and obtain access to activity records.

The identity of the behavioral data sources 28 and any associated credentials may be maintained as system criteria 32 (FIG. 3) and/or user specified criteria 34. The system criteria 32 and user specified criteria 34 may be maintained in a persistent storage, such as a flash drive or hard drive, and loaded into a random access memory as needed or desired by the TAM 24.

For each behavioral data source 28, the TAM 24 obtains activity records, if any, that identify activities of the sender 14 (step 106). Activity records may be obtained, for example, by requesting such activity records from a behavioral data source 28 that has implemented functionality for returning activity records of an identified individual upon request. For example, the social networking website 28A may implement an API that may be called by the TAM 24. The TAM 24 invokes an appropriate function of the API that includes the credentials of the recipient 22. The TAM 24 also provides to the API an identification of the sender 14. The identification may comprise an email address of the sender 14, a user identifier of the sender 14 known to the social networking website 28A, or the like. In response, the social networking website 28A searches the social networking website for postings of the sender 14, images shared by the sender 14, videos and audio files shared by the sender 14, profile information of the sender 14, and the like. Because the recipient 22 may be identified by the sender 14 as a “friend” or other such designation used by the social networking website 28A, the social networking website 28A may provide activity records that would not otherwise be provided without the credentials of the recipient 22.

According to another embodiment, the TAM 24 may provide credentials to the behavioral data source 28, and may “crawl” or otherwise search the behavioral data source 28 to obtain activity data identifying activities of the sender 14. For example, the TAM 24 may be aware of how to identify which movies have been rented by the sender 14 from the video rental website 28D, even if the video rental website 28D does not offer an API for that particular purpose. In either case, the TAM 24 obtains one or more activity records identifying an activity of the sender 14. The phrase “activity record” as used herein means information that identifies an activity of the sender 14, and does not require, imply, or suggest that the data be in any particular format.

An activity record may include data such as postings of the sender 14, comments made in any form by the sender 14, images shared by the sender 14, movies or other videos shared by the sender 14, questions answered by the sender 14, and the like.

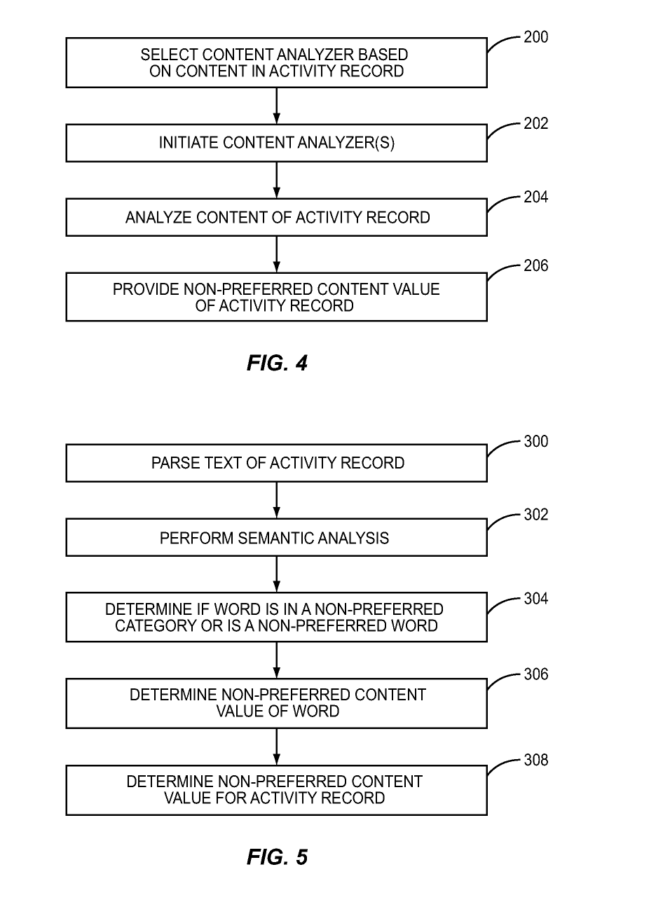

The TAM 24 analyzes the activity records to determine the content of the activity records (step 108). The TAM 24 may use one or more content analyzers 36A-36N (FIG. 3; generally, content analyzers 36) to analyze the activity records. Each content analyzer 36 may be suitable for analyzing a particular type of content. For example, the text content analyzer 36A may be suitable for analyzing textual content, such as postings and the like. The image content analyzer 36B may be suitable for analyzing image content, such as photographs. The audio content analyzer 36N may be suitable for analyzing audio content, such as an MP3 file that the sender 14 has made available for sharing. Additional details regarding the content analyzers 36 are described herein with reference to FIGS. 4-6.

The TAM 24 determines a non-preferred content value for each activity record based on non-preferred content identified in the activity record (step 110). After analyzing each activity record, the TAM 24 determines a total non-preferred content value for the message (step 112). The TAM 24 may determine a threat assessment quantifier based on the total non-preferred content value (step 114). The threat assessment quantifier may be equal to the total non-preferred content value, or may categorize the total non-preferred content value in some desired manner. For example, the threat assessment quantifier may categorize a total non-preferred content value of 0 as “Safe,” a total non-preferred content value between the range of 1 and 10 as “Unsure,” and a total non-preferred content value greater than 10 as “Threat.” Those of skill in the art will recognize these as merely exemplary, and that the form of the threat assessment quantifier may be in any desired format, such as numeric, alphabetic, a label, a color, and the like.

The TAM 24 directs the threat assessment quantifier and the message toward the recipient 22 (step 116). The threat assessment quantifier and message may be sent separately, or may be combined into a quantified message. According to one embodiment, the TAM 24 may wrap the message with a threat assessment wrapper to generate a quantified message. The threat assessment wrapper includes the threat assessment quantifier, and, optionally, data identifying non-preferred content. Table 1, below, is one example of a wrapped message using Extensible Markup Language (XML).

TABLE 1

<ThreatWrapper Level=”...” Ref=”...” URl=”...” >
<content>
[message from sender]
</content>
</ThreatWrapper>

According to another embodiment, the TAM 24 may add the threat assessment quantifier and any additional information to a header of the message to generate a quantified message. Additional information may include one or more of data identifying the non-preferred content, version information identifying a version of the TAM 24, a timestamp identifying the time the threat assessment was made, and/or an expiration time identifying an expiration time of the assessment. Alternately, rather than including such information with the message, a uniform resource identifier (URI) may be included with the message, which, upon selection by the recipient 22, retrieves the additional information for display to the user.

FIG. 4 is a flowchart illustrating steps for analyzing an activity record in greater detail. FIG. 4 will be discussed in conjunction with FIG. 3. The TAM 24 selects a particular content analyzer 36 based on content in the activity record obtained from a behavioral data source 28 (step 200). For example, if the content is textual, the text content analyzer 36A may be selected. If the content is an image, the image content analyzer 36B may be selected. Multiple content analyzers 36 may be used for an activity record that contains multiple types of content. The TAM 24 initiates the selected content analyzer(s) 36 (step 202). The content analyzer 36 analyzes the content in the activity record (step 204). The content analyzer 36 provides a non-preferred content value of the activity record based on the analysis (step 206).

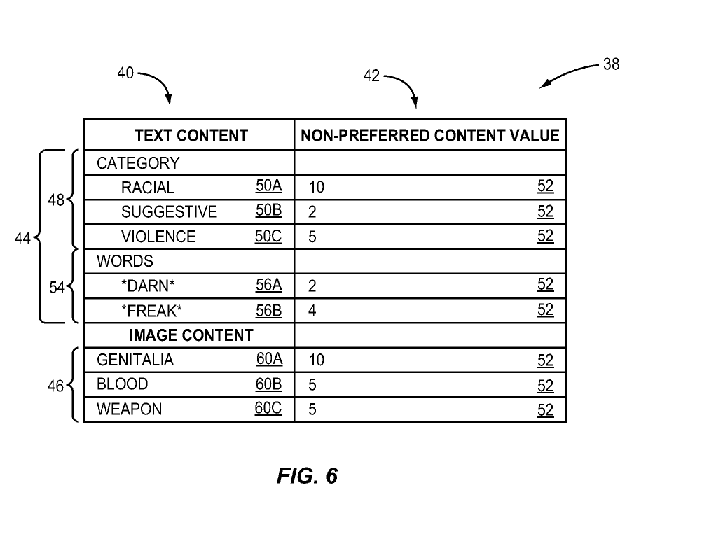

FIG. 5 is a flowchart illustrating in greater detail steps for analyzing an activity record that contains textual content, such as a textual posting of the sender 14. FIG. 6 illustrates an exemplary non-preferred content list 38 according to one embodiment of the invention. FIG. 5 will be discussed in conjunction with FIGS. 4 and 6. The text content analyzer 36A parses the textual content in the activity record into a plurality of words (step 300). Mechanisms for electronically parsing a string of text into words are known to those of skill in the art and will not be described in detail herein. The text content analyzer 36A accesses a non-preferred content list 38 (FIG. 6). In one embodiment, the non-preferred content list 38 may include a column 40 identifying non-preferred content and a column 42 identifying corresponding non-preferred content values. The column 40 includes a non-preferred text portion 44 and a non-preferred image portion 46. The non-preferred text portion 44 includes a category portion 48 identifying particular non-preferred categories 50A-50C (generally, non-preferred categories 50), each of which has a corresponding non-preferred content value 52. The non-preferred text portion 44 also includes a word portion 54 identifying a plurality of non-preferred words 56A, 56B. The non-preferred words 56A, 56B may include commonly used “wildcard” symbols such as “?” or “*” to include not only a particular word, but also derivations of the word, such as “freak” and “freaking.” It should be apparent that the non-preferred content list 38 is merely exemplary, and may in practice comprise multiple lists or data structures of any suitable format, and further that a separate data structure may be used for each type of content.

The text content analyzer 36A may use a semantic analyzer 58 (FIG. 3) to determine whether a particular word in the text of the activity record should be identified as a non-preferred category 50 (step 302). For example, the semantic analyzer 58 may access an ontology that categorizes words. Assume that the text content analyzer 36A, through the use of the semantic analyzer 58, determines that a word is properly categorized in a “violence” category. The text content analyzer 36A references the non-preferred content list 38 and determines that the “violence” category constitutes the non-preferred category 50C (step 304). The text content analyzer 36A then determines that the non-preferred content value 52 corresponding to the non-preferred category 50C is “5” (step 306). The text content analyzer 36A repeats this process for each word in the content to determine if the word is non-preferred content according to the non-preferred content list 38. At the end of the analysis, the text content analyzer 36A provides a non-preferred content value 52 for the activity record that is a sum of the non-preferred content values for each non-preferred word in the content.

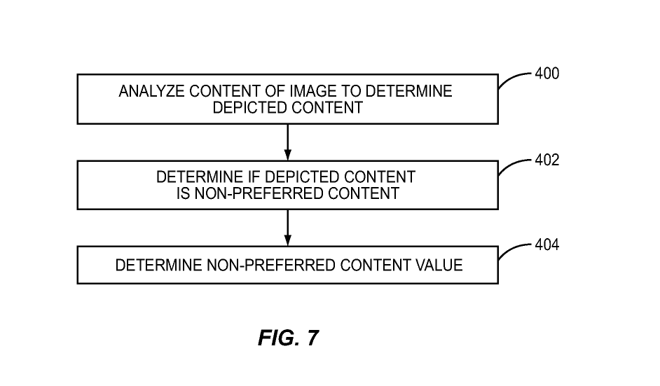

FIG. 7 is a flowchart illustrating steps for analyzing an activity record that contains image content, such as a digital photograph posted by the sender 14. FIG. 7 will be discussed in conjunction with FIG. 6. A non-preferred image portion 46 of the non-preferred content list 38 includes non-preferred image content 60A-60C (generally, non-preferred image content 60). The image content analyzer 36B processes the image content to determine depicted content in the image (step 400). Digital image processing technology capable of determining depicted content in an image is known to those of skill in the art and will not be described in detail herein. Assume that the image contains content that is determined to be a rifle. The image content analyzer 36B, through the use of the semantic analyzer 58, may process the word “rifle” and determine that a rifle is a “weapon.” The image content analyzer 36B accesses the non-preferred image content 60 to determine if the depicted content is non-preferred content (step 402). The image content analyzer 36B determines that a “weapon” constitutes non-preferred image content 60C. The image content analyzer 36B also determines that the corresponding non-preferred content value 52 for non-preferred image content 60C is “5” (step 404). The image content analyzer 36B repeats this process for each depicted content in the image. At the end of the analysis, the image content analyzer 36B provides a non-preferred content value for the activity record that is a sum of the non-preferred content values for each non-preferred content image in the content.

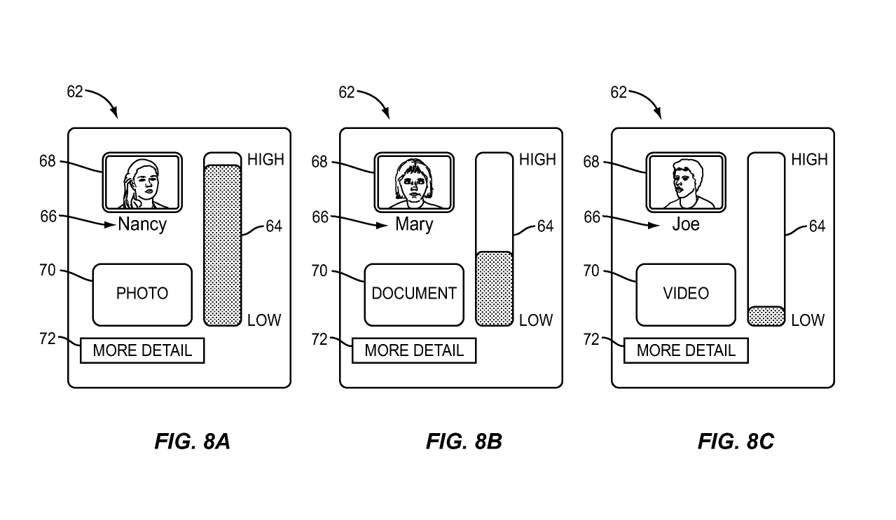

FIG. 8A illustrates an exemplary user interface for displaying a threat assessment based on a threat assessment quantifier associated with a message. A window 62 may include a threat assessment graphic 64 illustrating a threat assessment in terms of a bar graph. The threat assessment in this example is depicted as a “High” threat. The window 62 may also include a sender identification portion 66 identifying the sender 14 as “Nancy,” and if available, may also include a sender image 68 displaying an icon or image associated with the sender 14. The window 62 may further identify the type of content that is contained in the message in a content identification box 70. In this example, the content is a photograph, and the TAM 24 has determined that a “High” threat is associated with the photograph. The window 62 also includes a “more detail” button 72 which, if selected by the recipient 22, may cause the user interface to display additional detail about the threat assessment. For example, the user interface may identify the non-preferred image content that was the basis for the High-level threat assessment.

FIG. 8B illustrates another exemplary user interface for displaying a threat assessment based on the threat assessment quantifier associated with a message. In this example, the threat assessment graphic 64 indicates a mid-level threat. The content identification box 70 indicates that the type of content included in the message is a document. Upon selection of the more detail button 68, the user interface may identify the non-preferred words, or non-preferred categories, that were the basis of the threat assessment quantifier associated with the message.

FIG. 8C illustrates yet another exemplary user interface for displaying a threat assessment based on a threat assessment quantifier associated with a message. In this example, the threat assessment graphic 64 indicates a “Low”-level threat.

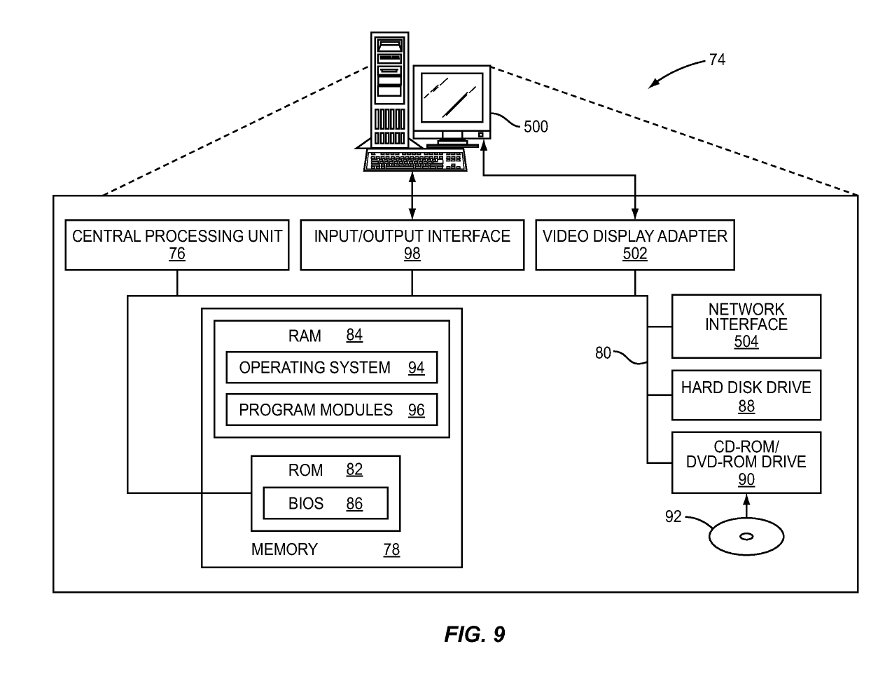

FIG. 9 illustrates an exemplary processing device 74 that may implement a TAM 24 according to one embodiment of the invention. The processing device 74 may, as discussed previously, comprise a network element 26 such as a switch, a router, a proxy server, and the like, a user communications device such as a cellular telephone, a computer, a PDA, and the like, or a residential network element 26 such as a router, a wireless access point, a cable modem, and the like. The exemplary processing device 74 includes a central processing unit 76, a system memory 78, and a system bus 80. The system bus 80 provides an interface for system components including, but not limited to, the system memory 78 and the central processing unit 76. The central processing unit 76 can be any of various commercially available or proprietary processors. Dual microprocessors and other multi-processor architectures may also be employed as the central processing unit 76.

The system bus 80 can be any of several types of bus structures that may further interconnect to a memory bus (with or without a memory controller), a peripheral bus, and a local bus using any of a variety of commercially available bus architectures. The system memory 78 can include non-volatile memory 82 (e.g., read only memory (ROM), erasable programmable read only memory (EPROM), electrically erasable programmable read only memory (EEPROM), etc.) and/or volatile memory 84 (e.g., random access memory (RAM)). A basic input/output system (BIOS) 86 can be stored in the non-volatile memory 82, which can include the basic routines that help to transfer information between elements within the processing device 74. The volatile memory 84 can also include a high-speed RAM such as static RAM for caching data.

The processing device 74 may further include an internal hard disk drive (HDD) 88 (e.g., enhanced integrated drive electronics (EIDE) or serial advanced technology attachment (SATA)) for storage. The processing device 74 may further include an optical disk drive 90 (e.g., for reading a compact disk read-only memory (CD-ROM) disk 92). The drives and associated computer-readable media provide non-volatile storage of data, data structures, computer-executable instructions, and so forth. For the processing device 74, the drives and media accommodate the storage of any data in a suitable digital format. Although the description of computer-readable media above refers to an HDD and optical media such as a CD-ROM or DVD, it should be appreciated by those skilled in the art that other types of media which are readable by a computer, such as Zip disks, magnetic cassettes, flash memory cards, cartridges, and the like, may also be used in the exemplary operating environment, and further, any such media may contain computer-executable instructions for performing novel methods of the disclosed architecture.

A number of program modules can be stored in the drives and volatile memory 84 including an operating system 94; one or more program modules 96 including, for example, the TAM 24; the display module 30; and other modules described herein. It is to be appreciated that the invention can be implemented with various commercially available operating systems or combinations of operating systems. All or a portion of the invention may be implemented as a computer program product, such as a computer usable medium having a computer-readable program code embodied therein. The computer-readable program code can include software instructions for implementing the functionality of the TAM 24 and other aspects of the present invention, as discussed herein. The central processing unit 76 in conjunction with the program modules 96 in the volatile memory 84 may serve as a control system for the processing device 74 that is adapted to implement the functionality described herein.

A user can enter commands and information into the processing device 74 through one or more wired/wireless input devices, for example, a keyboard and a pointing device, such as a mouse (not illustrated). Other input devices (not illustrated) may include a microphone, an infrared (IR) remote control, a joystick, a game pad, a stylus pen, a touch screen, or the like. These and other input devices are often connected to the central processing unit 76 through an input device interface 98 that is coupled to the system bus 80 but can be connected by other interfaces such as a parallel port, an IEEE 1394 serial port, a game port, a universal serial bus (USB) port, an IR interface, etc.

The processing device 74 may include a separate or integral display 500, which may also be connected to the system bus 80 via an interface, such as a video display adapter 502. The processing device 74 may operate in a networked environment using a wired and/or wireless communication network interface 504. The network interface 504 can facilitate wired and/or wireless communications to the network 16 (FIG. 1).

The processing device 74 may be operable to communicate with any wireless devices or entities operatively disposed in wireless communication, for example, a printer, a scanner, a desktop and/or portable computer via wireless technologies, such as Wi-Fi and Bluetooth, for example.

Embodiments of the invention have been provided herein for purposes of illustration and explanation, but those skilled in the art will recognize that many additional and/or alternative embodiments are possible. For example, while the process for determining a threat assessment quantifier has been described as being performed upon receipt of a message by the TAM 24, the TAM 24 could proactively and/or on an ongoing basis determine the threat assessment quantifier associated with one or more senders 14 and store such threat assessment quantifiers in a memory. For example, the TAM 24 may continually determine a threat assessment quantifier associated with prolific senders 14 who send a relatively high number of messages. Similarly, the TAM 24 may continually determine a threat assessment quantifier of senders 14 that are designated “friends” of a recipient 22. In such embodiment, the TAM 24 would not necessarily need to determine the threat assessment quantifier upon receipt of a message, but could identify the sender 14 and obtain the threat assessment quantifier associated with the sender 14 from the memory.

While the threat assessment quantifier has been described as being provided in a wrapper, in a header, or separately from the message, the invention is not limited to any particular transmission mechanism. For example, the threat assessment quantifier could be inserted into the message itself along with explanatory text. For example, an email message may be modified to begin “THREAT ASSESSMENT SERVICE: This email message has been assessed to have a threat value of 9 out of 10 . . . ” Alternatively, the original message may be delivered as an attachment, and the threat assessment quantifier, or threat assessment based on the threat assessment quantifier, may be provided as the content of the original email message. In yet another embodiment, the original email message may be stored on the server, and the threat assessment quantifier may be provided to the recipient 22 with a link, such as a URI, to the stored message.

Those skilled in the art will recognize improvements and modifications to the preferred embodiments of the present invention. All such improvements and modifications are considered within the scope of the concepts disclosed herein and the claims that follow.

What is claimed is:

1. A computer-implemented method for quantifying a threat associated with a sender of a message, comprising:
receiving, from a sender, a message directed to a recipient;
determining at least one behavioral data source;
obtaining an activity record from the behavioral data source, wherein the activity record contains content provided by the sender to the behavioral data source;
conducting an analysis of the content to determine whether the content contains non-preferred content;
generating a threat assessment quantifier based on the analysis; and
directing the threat assessment quantifier and the message toward the recipient.

2. The computer-implemented method of claim 1, wherein determining the at least one behavioral data source comprises receiving an identification of the at least one behavioral data source from the recipient.

3. The computer-implemented method of claim 2, further comprising receiving credentials identifying an account of the recipient associated with the at least one behavioral data source.

4. The computer-implemented method of claim 3, wherein obtaining the activity record further comprises providing the credentials to the at least one behavioral data source to authenticate with the at least one behavioral data source.

5. The computer-implemented method of claim 1, wherein the content comprises textual content, and wherein conducting the analysis of the content comprises parsing the textual content into a plurality of words, and determining if each of the plurality of words is identified on a non-preferred content list.

6. The computer-implemented method of claim 1, wherein the content comprises an image, and wherein conducting the analysis of the content comprises conducting an image analysis of the image to determine at least one depicted content, and determining if the at least one depicted content is identified on a non-preferred content list.

7. The computer-implemented method of claim 1, wherein generating the threat assessment quantifier based on the analysis comprises determining a non-preferred content value for each instance that the content contains non-preferred content, determining a total non-preferred content value based on a plurality of non-preferred content values, and determining the threat assessment quantifier based on the total non-preferred content value.

8. The computer-implemented method of claim 1 further comprising generating a wrapped message wherein the wrapped message comprises a wrapper which includes the threat assessment quantifier and the message, and wherein directing the threat assessment quantifier and the message toward the recipient comprises directing the wrapped message toward the recipient.

9. The computer-implemented method of claim 1 further comprising generating a modified message wherein a header of the message is modified to include the threat assessment quantifier, and wherein directing the threat assessment quantifier and the message toward the recipient comprises directing the modified message toward the recipient.

10. The computer-implemented method of claim 1 wherein directing the threat assessment quantifier and the message toward the recipient further comprises directing the threat assessment quantifier, the message and data identifying non-preferred content in the message toward to the recipient.

11. The computer-implemented method of claim 1 wherein directing the threat assessment quantifier and the message toward the recipient comprises sending the threat assessment quantifier and the message to a device associated with the recipient.

12. The computer-implemented method of claim 1 wherein directing the threat assessment quantifier and the message toward the recipient comprises providing the threat assessment quantifier and the message to a display module for display to the recipient.

13. The computer-implemented method of claim 1 wherein determining at least one behavioral data source comprises determining a plurality of behavioral data sources, wherein obtaining the activity record from the behavioral data source comprises obtaining a plurality of activity records, wherein the plurality of activity records includes a first activity record from a first of the plurality of behavioral data sources and a second activity record from a second of the plurality of behavioral data sources, and where conducting the analysis of the content comprises conducting an analysis of the first activity record and the second activity record.

14. The computer-implemented method of claim 13 wherein the first activity record comprises textual content.

15. The computer-implemented method of claim 14 wherein the second activity record comprises image content.

16. A processing device comprising:
a network interface adapted to communicate with a network; and
a control system coupled to the network interface and adapted to:
receive, from a sender, a message directed to a recipient;
determine at least one behavioral data source;
obtain an activity record from the behavioral data source,
wherein the activity record contains content provided by the sender;
conduct an analysis of the content to determine whether the content contains non-preferred content;
generate a threat assessment quantifier based on the analysis;
couple the threat assessment quantifier with the message to generate a quantified message; and
direct the quantified message toward the recipient.

17. The processing device of claim 16, wherein to determine the at least one behavioral data source, the control system is adapted to receive an identification of the at least one behavioral source from the recipient.

18. The processing device of claim 16 wherein to determine the at least one behavioral data source the control system is further adapted to determine a plurality of behavioral data sources, wherein to obtain the activity record from the behavioral data source the control system is further adapted to obtain a plurality of activity records, wherein the plurality of activity records includes a first activity record from a first of the plurality of behavioral data sources and a second activity record from a second of the plurality of behavioral data sources, and wherein to conduct the analysis of the content, the control system is further adapted to conduct an analysis of the first activity record and the second activity record.

19. A computer program product, comprising a computer usable medium having a computer readable program code embodied therein, the computer readable program code adapted to be executed to implement a method for quantifying a threat associated with a sender of a message, comprising:
receiving, from the sender, a message directed to a recipient;
determining at least one behavioral data source;
obtaining an activity record from the behavioral data source, wherein the activity record contains content provided by the sender;
conducting an analysis of the content to determine whether the content contains non-preferred content;
generating a threat assessment quantifier based on the analysis;
coupling the threat assessment quantifier with the message to generate a quantified message; and
directing the quantified message toward the recipient.

20. The computer program product of claim 19 wherein determining the at least one behavioral data source comprises determining a plurality of behavioral data sources, wherein obtaining the activity record from the behavioral data source comprises obtaining a plurality of activity records, wherein the plurality of activity records includes a first activity record from a first of the plurality of behavioral data sources and a second activity record from a second of the plurality of behavioral data sources, and wherein conducting the analysis of the content comprises conducting an analysis of the first activity record and the second activity record.
